(19) United States
(12) Patent Application Publication
(10) Pub. No.: US 2026/0030013 A1
(43) Pub. Date: Jan. 29, 2026

(54) BALANCING QUALITY AND TECHNICAL COST OF UPDATING DEPENDENCIES IN SOFTWARE SYSTEMS

(71) Applicant: SAP SE, Walldorf (DE)

(72) Inventor: Damien Jaime, Nanterre (FR)

(21) Appl. No.: 18/981,854

(22) Filed: Dec. 16, 2024

Related U.S. Application Data
(60) Provisional application No. 63/675,124, filed on Jul. 24, 2024.

(51) Int. Cl. G06F 8/65

(52) U.S. Cl. CPC G06F 8/65

(57) ABSTRACT

Methods, systems, and computer-readable storage media for a software dependency update system that processes computer-readable files (e.g., source code file, dependency description file) of a software project to generate an updated dependency graph using linear programming in view of a set of quality metrics for updating dependencies of the software project.

### CROSS-REFERENCE TO RELATED APPLICATIONS

This application claims priority to and the benefit of U.S. Prov. App. 63/675,124, filed on Jul. 24, 2024, the disclosure of which is expressly incorporated herein by reference in the entirety.

### BACKGROUND

Modern software systems are modular and reuse multiple, disparate components, such as libraries. For example, instead of creating new components from scratch, libraries that provide desired functionality are incorporated into software projects. These libraries expose features through application programming interfaces (APIs), which dictate the interactions between client-side functionality and libraries. Components within a software system are dependent on other components. For example, functions of one component can depend on functions of one or more other components.

Components underlying a software system, and thus the software system itself, evolve over time. For example, components can be updated to provide additional functionality, modified functionality, address security concerns (e.g., patches), and the like. Such evolution can impact dependencies between components and, as such, the dependencies need to be updated over time. However, updating dependencies between components in software systems is a crucial software maintenance task that requires significant effort in terms of time and technical resources. For example, which dependencies to update must be selected, appropriate target versions of components must be determined, and the impact of updates in terms of breaking changes and incompatibilities need to be minimized. Several factors influence the choice of a new dependency version, including its freshness, popularity, absence of vulnerabilities, and compatibility.

### SUMMARY

Implementations of the present disclosure are directed to updating dependencies in software systems. More particularly, implementations of the present disclosure are directed to a software dependency update system that processes computer-readable files (e.g., source code file, dependency description file) of a software project to generate an updated dependency graph using linear programming in view of a set of quality metrics for updating dependencies of the software project.

In some implementations, actions include receiving a source code file and a dependency description file of a software project, receiving a set of quality metrics, each quality metric having a weight assigned thereto, generating a rooted dependency graph including a first set of nodes, each node in the first set of nodes directly depending from a root node of the software project, extending the rooted dependency graph to provide a rooted extended dependency graph that includes the first set of nodes and a second set of nodes, a first sub-set of nodes of the second set of nodes representing current dependencies in the software project and a second sub-set of nodes of the second set of nodes representing potential dependencies in an updated version of the software project, generating a linear program using the rooted extended dependency graph, the set of quality metrics, and a weight function, the linear program being executable to optimize an objective function, processing the linear program using a solver to generate a solution that represents a third set of nodes and a set of edges between nodes in the third set of nodes that optimize the objective function, providing an updated dependency file for the software project that is representative of the solution, and updating the software project using the updated dependency file. Other implementations of this aspect include corresponding systems, apparatus, and computer programs, configured to perform the actions of the methods, encoded on computer storage devices.

These and other implementations can each optionally include one or more of the following features: a first sub-set of nodes in the third set of nodes represents direct dependencies to the root node and a second sub-set of nodes in the third set of nodes represents indirect dependencies to the root node; the objective function is optimized by minimizing the objective function; the objective function accounts for a quality of the solution in terms of an aggregation of quality metrics of the set of quality metrics and a cost of the solution in terms of change to one or more dependencies in the software project; actions further include normalizing values of quality metrics in the set of quality metrics before processing the linear program; the rooted extended dependency graph includes a set of change edges, each change edge being between the root node and a non-root node and representing a cost to change dependency between the root node and the non-root node; and the set of quality metrics includes a vulnerability metric, a freshness metric, and a popularity metric.

The present disclosure also provides a computer-readable storage medium coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure can include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example architecture that can be used to execute implementations of the present disclosure.

FIG. 2 depicts a portion of an example dependency graph to illustrate implementations of the present disclosure.

FIG. 3 depicts an example process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure are directed to updating dependencies in software systems. More particularly, implementations of the present disclosure are directed to a software dependency update system that processes computer-readable files (e.g., source code file, dependency description file) of a software project to generate an updated dependency graph using linear programming in view of a set of quality metrics for updating dependencies of the software project.

Implementations can include actions of receiving a source code file and a dependency description file of a software project, receiving a set of quality metrics, each quality metric having a weight assigned thereto, generating a rooted dependency graph including a first set of nodes, each node in the first set of nodes directly depending from a root node of the software project, extending the rooted dependency graph to provide a rooted extended dependency graph that includes the first set of nodes and a second set of nodes, a first sub-set of nodes of the second set of nodes representing current dependencies in the software project and a second sub-set of nodes of the second set of nodes representing potential dependencies in an updated version of the software project, generating a linear program using the rooted extended dependency graph, the set of quality metrics, and a weight function, the linear program being executable to optimize an objective function, processing the linear program using a solver to generate a solution that represents a third set of nodes and a set of edges between nodes in the third set of nodes that optimize the objective function, providing an updated dependency file for the software project that is representative of the solution, and updating the software project using the updated dependency file.

To provide further context for implementations of the present disclosure, and as introduced above, updating dependencies between components in software systems is a crucial software maintenance task that requires significant effort in terms of time and technical resources. For example, which dependencies to update must be selected, appropriate target versions of components must be determined, and the impact of updates in terms of breaking changes and incompatibilities need to be minimized. Several factors influence the choice of a new dependency version, including its freshness, popularity, absence of vulnerabilities, and compatibility.

In further detail, the way dependencies are managed varies across different software ecosystems. For example, a package manager or build system can be used to automatically retrieve specific versions of dependencies from remote software repositories, along with their own (transitive) dependencies, in order to build a so-called dependency graph, discussed in further detail herein. For example, JavaScript and TypeScript developers can use npm or Yarn (package manager that can be used to manage package dependencies) to fetch dependencies from the npm registry, while Java developers can use Maven or Gradle (build automation systems) to retrieve dependencies from the Maven Central repository.

Libraries continuously evolve to incorporate new features, bug fixes, security patches, refactorings, and the like. Entities that use software systems incorporating the libraries must stay up to date with the libraries to benefit from the improvements and to avoid technical lag and the associated technical debt (technical issues that arise as an expense of expediting delivery of software). However, when a library evolves, it can introduce changes that can result in syntactic and semantic errors. As such, developers are faced with the challenge of maximizing the freshness and quality of the dependencies, while minimizing the costs associated with updating the dependencies. This challenge is further complicated by the nature of dependency graphs. For example, updating a single dependency can cause a snowball effect and result in incompatibilities with other indirect dependencies. As a result, clients sometimes hesitate to update their dependencies, raising security concerns and making future updates even more difficult.

Updating of dependencies can include, for example, identifying client-side code that is affected by breaking changes, automatically migrating client-side code, and finding versions that minimize the impact on the dependency graph. In general, client-side code refers to source code that has dependencies to one or more libraries (e.g., external libraries provided by third-parties). UPCY, which is a tool that can be used to update dependencies, takes a library and a target version as input to construct a migration plan that seeks to minimize the number of breaking changes within the dependency graph induced by the update. While this approach is particularly suitable for updating a single dependency to a specific version, it is much less suitable for updating the entire dependency graph at once, which is critical for managing technical debt in decaying software projects. Besides, breaking changes may not accurately reflect the actual impact an update has, as it has been empirically shown that many breaking releases do not impact client projects in practice.

Further, migrating to the latest available version of each dependency may not always be the optimal choice. Various criteria must be juggled to find a satisfactory solution, ranging from ensuring license consistency across projects to minimizing security vulnerabilities and easing the migration process.

In view of the above context, implementations of the present disclosure provide a software dependency update system that addresses updates to dependencies between components (modules, libraries) of software systems. More particularly, and as described in further detail herein, the software dependency update system addresses updates to dependency graphs as a custom multi-objective optimization problem, and can use updated dependency graphs to update dependencies between components of software systems. In some implementations, the optimization problem is formulated as a linear programming problem on a project-rooted extended dependency graph. Implementations of the present disclosure are generic regarding the quality and cost metrics considered. As different developers prioritize these criteria differently, the multi-objective problem of the present disclosure incorporates weights for each, hence supporting updates tailored to organizational rules or individualized preferences. While other criteria can be considered, experimental evaluation of implementations of the present disclosure focus on the joint use of a set of quality metrics, which include dependency freshness (to minimize the cost of future updates), a time-window popularity measure (as a proxy for community support), and a vulnerability score based on Common Vulnerabilities and Exposures (CVEs) (as a proxy for security concerns). For the cost of change, the impact breaking changes introduced in a release have on the project is estimated.

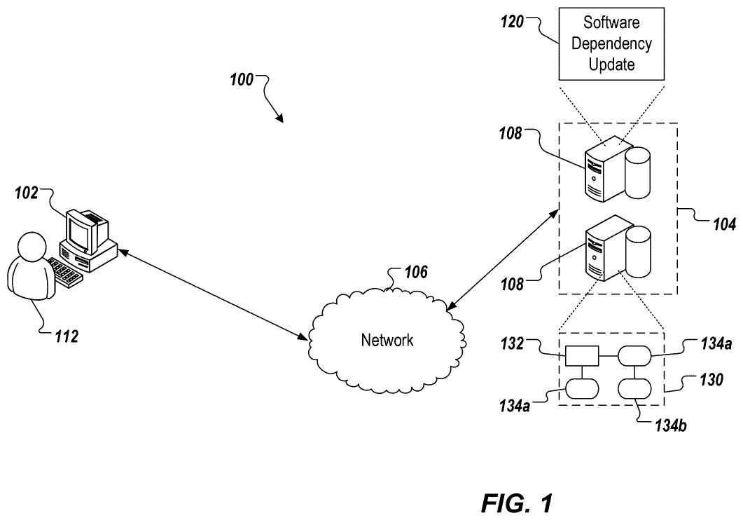

FIG. 1 depicts an example architecture 100 in accordance with implementations of the present disclosure. In the depicted example, the example architecture 100 includes a client device 102, a network 106, and a server system 104. The server system 104 includes one or more server devices and databases 108 (e.g., processors, memory). In the depicted example, a user 112 interacts with the client device 102.

In some examples, the client device 102 can communicate with the server system 104 over the network 106. In some examples, the client device 102 includes any appropriate type of computing device such as a desktop computer, a laptop computer, a handheld computer, a tablet computer, a personal digital assistant (PDA), a cellular telephone, a network appliance, a camera, a smart phone, an enhanced general packet radio service (EGPRS) mobile phone, a media player, a navigation device, an email device, a game console, or an appropriate combination of any two or more of these devices or other data processing devices. In some implementations, the network 106 can include a large computer network, such as a local area network (LAN), a wide area network (WAN), the Internet, a cellular network, a telephone network (e.g., PSTN) or an appropriate combination thereof connecting any number of communication devices, mobile computing devices, fixed computing devices and server systems.

In some implementations, the server system 104 includes at least one server and at least one data store. In the example of FIG. 1, the server system 104 is intended to represent various forms of servers including, but not limited to a web server, an application server, a proxy server, a network server, and/or a server pool. In general, server systems accept requests for application services and provides such services to any number of client devices (e.g., the client device 102 over the network 106).

In accordance with implementations of the present disclosure, and as noted above, the server system 104 can host a software dependency update system 120 that addresses updates to dependencies between components (libraries) of software systems. In some examples, the software dependency update system 120 can include one or more user interfaces (UIs) that enable users to interact with the software dependency update system 120. In some examples, the UIs can enable a user to select a software project that is to have its dependencies updated, upload files for the software project (described in further detail herein), define quality metrics, weights, and the like. For example, the software dependency update system 120 can update dependencies of a software system 130 that includes a module 132 (client-side code) that is dependent on libraries 134a, 134b. In the example of FIG. 1, the module 132 is directly dependent on the libraries 134a and is indirectly dependent on the library 134b. More particularly, and as described in further detail herein, the software dependency update system 120 addresses updates to dependency graphs as a custom multi-objective optimization problem, and can use updated dependency graphs to update dependencies between components of software systems. An updated dependency graph can be generated for the software system 130, which can be used to update the dependencies of the software system 130.

In further detail, the software dependency update system automatically proposes a dependency update plan from developer-defined preferences. In a non-limiting, example implementation, the software dependency update system targets the Java programming language and the Maven ecosystem and leverages the Maven Dependency Graph and the enrichment capabilities provided by Goblin to incorporate quality and cost metrics into dependency graphs. Maven can be described as a software project management and comprehension tool that can generate dependency graphs. Goblin can be described as a framework for enriching and querying dependency graphs provided by Maven. In the non-limiting, example implementation, the software dependency update system leverages Maracas to measure the impact of breaking changes on client code (e.g., code of modules). Maracs can be described as a source code and bytecode analysis framework.

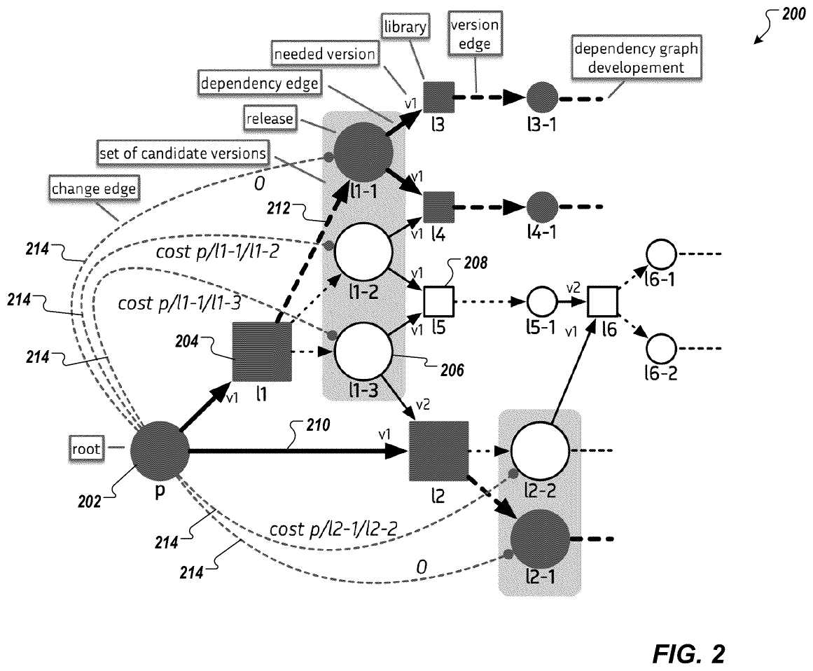

FIG. 2 depicts a portion 200 of an example dependency graph G to illustrate implementations of the present disclosure. The portion 200 of the example dependency graph G is used as a non-limiting example to illustrate challenges of balancing the quality and cost of updating dependencies. In the depicted example, the portion 200 includes a set of nodes, such as nodes 202, 204, 206, 208, among several nodes, and a set of edges, such as edges 210, 212, 214, among several other edges, each edge connecting a pair of nodes. In the example of FIG. 2, the node 202 represents a root project p (software project). For example, the root project p is represented by shaded nodes, such as the nodes 202, 204. That is, the shaded nodes represent the current state, in terms of dependencies, of the root project p. Unshaded nodes, such as the nodes 206, 208, represent other possible dependencies, but are not (yet) in the current state of the root project p.

In the example of FIG. 2, square nodes, such as the node 204, represent libraries, and round nodes, such as the node 206, represent versions of a library. For example, the node 206 represents a version l1-3 of the library l1 represented by the node 204, where the library l1 includes versions l1-1, l1-2, l1-3 as possible alternatives. The direct dependencies and the indirect dependencies of the alternative versions are depicted with unshaded nodes (e.g., the nodes 206, 208). In the example of FIG. 2, the current dependencies of the root project p are {l1-1, l2-1, l3-1, l4-1}. Potential, alternative dependency graphs for the root project p are {l1-1, l2-2, l3-1, l4-1, l6-1}, {l1-1, l2-2, l3-1, l4-1, l6-2}, {l1-2, l2-1, l4-1, l5-1, l6-1}, {l1-2, l2-1, l4-1, l5-1, l6-2}, {l1-2, l2-2, l4-1, l5-1, l6-1}, {l1-2, l2-2, l4-1, l5-1, l6-2}, {l1-3, l2-1, l5-1, l6-1}, {l1-3, l2-1, l5-1, l6-2}, {l1-3, l2-2, l5-1, l6-1}, and {l1-3, l2-2, l5-1, l6-2}, where underlined library versions indicate changes from the current dependencies of the root project p.

Continuing with the example of FIG. 2, the current dependencies of the root project p include direct dependencies to libraries l1 (in version l1-1) and l2 (in version l2-1) and indirect dependencies to libraries l3 (in version l3-1) and l4 (in version l4-1). Each library offers a set of releases that act as candidates for replacing existing dependency versions (l1, for example, offers releases l1-1, l1-2, and l1-3, with l1-3 being the most recent release). Migrating from one library version to another incurs a change cost, depicted with dotted edges, such as the edges 214.

Updating the dependencies of the root project p involves finding a sub-graph G′ of the dependency graph G that satisfies ecosystem-specific, well-formedness constraints (e.g., one can only directly depend on a single version of a given library), maximizes the quality of each dependency in the graph rooted in p, and minimizes the cost of migrating to new versions. A given solution must specify the version of each dependency, whether direct or transitive, to ensure that no version is left open for the dependency resolver to pick arbitrarily. The goal is to find an optimal solution with respect to specific user-defined quality and cost preferences. Even in the relatively simple example of FIG. 2, combining every candidate version of each library yields ten candidate sub-graphs G′. In real-world settings, with dozens to hundreds of dependencies, the number of possible solutions quickly becomes unmanageable with traditional approaches.

In considering alternatives, several factors can be considered when selecting a dependency. These can range from its freshness and the compatibility of its license with the project, to the absence of known security vulnerabilities (CVEs) and/or its overall popularity and community support. As discussed in further detail herein, implementations of the present disclosure focus on quality metrics of freshness, popularity, and the number of known vulnerabilities. However, it can be noted that implementations of the present disclosure are generic and extensible, such that any appropriate criteria can be integrated (e.g., licensing constraints).

With non-limiting reference to the example of FIG. 2, consider a simple case where the freshness of dependencies is to be maximized, while minimizing the cost of migrating to the most-recent versions of the libraries. Updating would mean choosing {l1-3, l2-2, l5-1, l6-2}, assuming that these do not incur significant costs in terms of breaking changes. Another approach may be to prioritize maximizing the freshness of dependencies and minimizing the presence of vulnerabilities, regardless of the cost of migrating to the new configuration. A successful approach should enable developers to (i) precisely express quality and cost preferences, and (ii) determine an optimal solution based on these preferences within a reasonable time.

Accordingly, and as described in further detail herein, the software dependency update system of the present disclosure considers the impact of breaking changes on the root project p and enables simultaneously updating of all project dependencies. More particularly, dependency updates should incorporate static analysis to compensate for the inadequacy of regression tests (e.g., test suites designed to detect regression caused by dependency updates have been shown to only detect 47% of artificial faults injected in direct dependencies and 35% of those injected in indirect dependencies). Implementations of the present disclosure incorporate the precise cost of dependency updates directly within the dependency graph.

In further detail, Algorithm 1 can be executed (by the software dependency update system) to update dependencies of a software project p in accordance with implementations of the present disclosure:

Algorithm 1: Update Project Dependencies

```
Inputs: project p (source code and dependency description file),
Q⁺ = Q ∪ {cost}
    the set of metric values, w weight function
Outputs: p′ an update of p
  1: G ← computeRDG(p.dependencies, Q)
  2: G ← extendRDG(p, G)
  3: G ← normalize(G, Q⁺)
  4: program ← generateLinearProgram(G, Q⁺, w)
  5: solution ← solve(program)
  6: p′ ← update(p, solution)
  7: return p′
```

As represented above, Algorithm 1 includes constructing the dependency graphs and solving the dependency update using linear programming. Here, the input includes the project p as source code (e.g., Java file) and a corresponding dependency description file. In some examples, the dependency description file (e.g., provided as an extensible markup language (XML) file) contains information about the project and configuration details used to build the project (e.g., build directory, source directory, test source directory). The input further includes a non-empty set Q of user-chosen quality metrics, to which a specific cost of change metric (cost) is added, which yields a set Q⁺, and a weight function w that associates, to each q in Q⁺, a user-defined weight (e.g., in [0,1]), with w_{q} denoting the weight for q. It can further be required that Σ_{q∈Q} w_{q}=1 (the sum of weights for quality metrics is 1), which means that this means that Σ_{q∈Q}_{⁺} w_{q}.

With continued reference to Algorithm 1, a dependency graph, called the rooted dependency graph (rDG) is constructed from p's direct dependencies. In addition to containing all direct and indirect dependencies for p, the rDG also includes additional libraries and releases corresponding to a potential for update. This information is extracted from the whole dependency graph. Values for the quality metrics of interest are computed and associated with each release in the rDG. The rDG is extended into a rooted extended dependency graph (rEDG) with information related to the cost of change when switching from one library version to another library version, based on the practical use of the library by project p.

In accordance with implementations of the present disclosure, the update is formulated as a linear program using the rEDG, quality metrics, cost of change, and weight function. The objective is to determine the optimal set of dependency updates that balance quality improvement and cost of change. Because quantitative information (values for quality metrics and change cost) can vary significantly in scale, normalization is performed to ensure a consistent basis for comparison when using linear programming. After normalization, encoding is executed to generate a linear program (program) and a linear programming solver processes the linear program to find the optimal solution (solution). It is appreciated that a solution always exists. For example, the solution can be p's current set of dependencies (i.e., no updates). In the case of updated dependencies, the solution indicates which part of the rEDG should be considered to update p's dependencies.

Implementations of the present disclosure are described in further detail herein with reference to example models and graph construction.

In some examples, a model is used to represent dependencies and versioning between libraries and releases of the libraries. Such models can be retrieved from software ecosystems to address ecosystem-wide research questions and support software-related maintenance processes. A dependency graph model can be defined as follows: a Dependency Graph (DG) G is a tuple (N_{L}, N_{R}, E_{D}, E_{V}, req) where N_{L} is a set of library nodes, N_{R} is a set of release nodes, E_{D}⊆N_{R}×N_{L} is the dependency relation (edges), E_{V}⊆N_{L}×N_{R} is the version relation (edges), and req is a version constraint function associating to each edge in E_{D} a version in a set Ver denoting semantic versions. Further, N=N_{L}∪N_{R} and E=E_{D}∪E_{V}.

An edge e=(r,l) in E_{D} denotes a dependency relation between release r and library l, with required version being req(e). A preliminary experiment reveals that, on Maven Central (a software project repository in Maven), only approximately 1% of dependency relations use range version requirements (e.g., [1.0, 2.0]). Hence, it is assumed that Ver strictly corresponds to semantic versions, not ranges. An edge (l, r) in E_{V} denotes a version relation between l and r meaning that r is a version of l.

With regard to rooted dependency graphs, a DG G is rooted, when G has a distinct node p in N_{R} and G contains only nodes and edges that are reachable from p. In some examples, only rooted DGs (rDGs) are used, because the objective is to update the dependencies of a project of interest that acts as the root of the graph. There are different strategies to compute rDGs when it comes to the versions of libraries. For libraries that are direct dependencies of the root, a strategy could, for example, keep all versions, only versions newer than the one currently required by the root, or only non-patch versions. The same choice applies to libraries that are indirect dependencies of the root. The choice of a strategy to compute a rDG has implications on its size, the possible updates, and the time/memory required to compute the best update plan.

With regard to extended dependency graphs, to support dependency updates, rDGs are extended with a type of edge denoting the cost of changing from one version to another. This is done using change edges (e.g., the edges 214 of FIG. 2) and a cost function associated with the change edges. For example, an extended dependency graph (EDG) G is a tuple (N_{L}, N_{R}, E_{D}, E_{V}, E_{C}, req, cost) such that (N_{L}, N_{R}, E_{D}, E_{V}, req) is a DG and E_{C}⊆N_{R}×N_{R} is the change relation (edges), and cost is a cost function associating to each edge in E_{C} a cost in some abstract set Cost (a measure of change debt is typically used here, see in the sequel). Further, we require that there can only be an edge (r₁, r₂) in E_{C} when there is an edge (r₁,l) in E_{D} and an edge (l, r₂) in E_{V}.

With regard to rooted extended dependency graphs, and as for DGs and rooted DGs, EDGs and rooted EDGs (rEDGs) are provided. As for the computation of rDGs, the computation of change edges is a matter of strategy. The global strategy is to compute the maximal set of possible change edges (all that fulfill the requirements in of an rEDG, discussed above). The local strategy, on the other hand, is to compute only change edges outgoing from the root.

For purposes of illustration, the non-limiting example of FIG. 2 can be discussed, which depicts an example of a rEDG. Here, the strategy for the computation of the rDG is to include all versions for direct dependencies. For indirect dependencies, the strategy is to include only the versions that are required (e.g., the two versions of l6). Even if l3, l4, or l5 had more than one version, only one would be present in the graph. The strategy for computing the change edges to obtain the rEDG is to include all possible change edges for the root and none for the other nodes. Other combinations of strategies would have produced different rEDGs.

To construct the rDG for a project p, features provided by frameworks, such as Goblin, are used. This can include the whole Maven Central dependency graph (stored in a graph database), the ability to extract sub-graphs using predefined REST routes or Cypher queries, and the ability to compute and insert additional metrics on the nodes and edges of the graphs. A release strategy dictates where dependencies are expanded into candidate versions. For example, only for direct dependencies (the “local” strategy) or for all direct and indirect dependencies (the “global” strategy). Even with a local strategy, multiple versions can co-exist for an indirect dependency (e.g., l6 in FIG. 2).

With regard to additional metrics that can be inserted, CVE and freshness metrics associated with release nodes can be used. For freshness, as-is metrics (e.g., as computed by Goblin) can be reused. For CVEs, a post-treatment can be performed. For example, Goblin only provides a list of CVEs that impact a release. However, to make the list of CVEs usable for updating, the number of CVEs in each of four criticality categories (low, moderate, high, critical) and are computed and aggregated using coefficients (e.g., from the Fibonacci suite).

After obtaining the rDG, the rDG is extended (to provide the rEDG) with the edges in E_{C} and the values in cost to integrate the cost of change in the update process. The first step is to determine the desired change edges. This decision is based on strategy, as discussed herein. The local strategy involves computing change edges only between the root and its direct dependencies, as shown in FIG. 2, while the global strategy involves computing change edges whenever a library in the rDG has multiple versions to consider indirect change costs. For example, in FIG. 2, the global strategy would involve adding six additional change edges: (l2-2, l6-1), (l2-2, l6-2), (l1-3, l2-1), (l1-3, l2-2), (l5-1, l6-1), and (l5-1, l6-2).

The idea behind the computation of the cost of change is to accept possible breaking changes in exchange for a better overall quality of the dependencies. The cost of change is computed as follows for each change edge. Suppose a release r that depends on a library l and uses its version rᵢ (as specified by req). Suppose the cost on the change edge between r and another version of l is to be computed, rⱼ, for example. To compute the cost, Maracas can be used with the jar file of rᵢ, the jar file of rⱼ, and the source code of r. Maracas computes all breaking changes (removed methods, changed exceptions, altered visibilities, etc.) between rᵢ and rⱼ, and the impact these changes would have on the code of r (unresolved methods, uncaught exceptions, etc.) as a set of broken uses. The number of broken uses, the number of code locations in r that would be impacted by the update from rᵢ to rⱼ, constitutes the cost on the corresponding change edge.

It can be noted that, in the case that possible breaking changes in indirect dependencies can be accepted (e.g., for l5-1 (resp. l2-2) using l6-1 (resp. l6-2) instead of l6-2 (resp. l6-1)), Maracas cannot be used to compute the cost of change as it not suited to measuring the impact of indirect dependencies. In such cases, the Japicmp tool can be used.

As discussed above, a linear program (e.g., program in Algorithm 1) is generated and executed to maximize the quality of dependencies, while minimizing the cost of change. In a linear program, sets of elements include a set of decision variables and a set of constraints, and an objective function is provided. Here, the constraints and the objective function are linear. The output of a linear program is the optimal value of the objective function (maximum or minimum) and the corresponding values of the decision variables that achieve this optimum.

In accordance with implementations of the present disclosure, the following decision variables are used. For each library l in N_{L}, a binary variable

$${v}_{l}^{lib}$$

represents whether l is present (equals 1) or not (equals 0) in the solution. For each release r in N_{R}, a binary variable

$$v {}_{r}^{rel}$$

represents whether r is present in the solution. For each change edge between release nodes r and r′ in E_{C}, a binary variable

$$v {}_{{rr}^{′}}^{chg}$$

represents whether the edge is present in the solution. These decision variables are used in the sequel to express constraints that an update solution must fulfill.

A set of conditions are used to determine whether an update solution is correct (whether optimal). For releases, (a) if the root is present, (b) if a release (including root) is present then all its dependencies (libraries) are present, and (c) if a release (but for root) is present then the library it is a version of is present. For libraries, if a library is present, then (d) exactly one of its versions (releases) is present and (e) at least one of its dependents (releases) is present. For change edges, (f) if a change edge (r, r′) is present then both r and r′ are present, and (g) conversely, if two nodes r and r′ connected by a change edge are present then the change edge is present. Here, present means that some node or edge is included in the solution (i.e., the corresponding variable is set to 1). The set of constraints that encode these conditions are provided as follows (the correspondence being (1)⇔(a), (2)⇔(b), (3)⇔(c)∧(d), (4)⇔(e), and (5)⇔(f)∧(g)):

$${v}_{p}^{rel} = 1 \qquad ( 1 )$$

$$∀ d = ( r , l ) ∈ {E}_{D} , {v}_{1}^{lib} \geq {v}_{r}^{rel} \qquad ( 2 )$$

$$∀ l ∈ {N}_{L} , {\sum }_{{l}_{i} ∈ \{ {l}_{i} \vert ( l , {l}_{i} ) ∈ {E}_{V} \}} {v}_{{l}_{i}}^{{rel}_{=}} {v}_{l}^{lib} \qquad ( 3 )$$

$$∀ l ∈ {N}_{L} , {\sum }_{r ∈ \{ r \vert ( r , l ) ∈ {E}_{D} \}} {v}_{r}^{rel} \geq {v}_{l}^{lib} \qquad ( 4 )$$

$$∀ e = ( r , {r}^{′} ) ∈ {E}_{c} , {v}_{{rr}^{′}}^{c h g} = {v}_{r}^{rel} \times {v}_{{r}^{′}}^{rel} ( which , using linearization , becomes ∀ e = ( r , {r}^{′} ) ∈ {E}_{C} ) \qquad ( 5 )$$

$${v}_{{rr}^{′}}^{c h g} \leq {v}_{r}^{rel} \qquad ( 6 a )$$

$${v}_{{rr}^{′}}^{c h g} \leq {v}_{{r}^{′}}^{rel} \qquad ( 6 b )$$

$${v}_{{rr}^{′}}^{c h g} \geq {v}_{r}^{rel} + {v}_{{r}^{′}}^{rel} - 1 \qquad ( 6 c )$$

Using the above definition of a correct dependency update solution, the software dependency update system of the present disclosure finds one solution that is indeed optimizing conflicting criteria, namely, quality and cost. Multi-Objective Multi-Criteria Decision-Making is the field concerned with solving such problems. A difficulty here stems from the presence of more than one criterion, with some to be maximized and some to be minimized. Multiple Pareto optimal solutions usually exist in such a case. Therefore, many methods to solve Multi-Objective Multi-Criteria (MO-MC) optimization problems proceed by transforming them into a Single-Objective Single-Criterion (SO-SC) problem.

To make this transformation, implementations of the present disclosure can use Simple Additive Weighting (SAW), which is based on weights (e.g., assigned by the developer) to each criterion. In general, SAW can include combining multiple criteria values into a single criterion value using a weighted sum. Before this phase, SAW requires a normalization phase to scale criteria values and compare the ratings of all existing solutions. Some of the criteria are positive (w.r.t. maximizing an objective function), the higher the value, the higher the quality. This includes popularity metrics, such as star ratings, number of downloads, and the like. Other criteria are negative (w.r.t. maximizing an objective function), the higher the value, the lower the quality. This includes criteria, such as the cost of change or the vulnerability score related to CVEs. Various normalization techniques are available and can be selected from by taking into account the objective function (e.g., should it be maximized or minimized) and the nature of the criteria (e.g., positive or negative w.r.t. the objective function).

In some implementations, the linear programming solver (solve in Algorithm 1) attempts either to maximize or minimize the value of the objective function by adjusting the values of the decision variables while enforcing the constraints. When updating dependencies, a goal is to maximize certain quality metrics (e.g., popularity), while minimizing change cost and other quality metrics (e.g., vulnerabilities). To make this amenable to a SO problem, the following perspective can be adopted: consider that quality metrics are a measure of a form of quality debt, and thus they should also be minimized. This inversion enables the focus to be solely on criteria to minimize. Therefore, positive metrics, like popularity, are treated as negative criteria for minimization. Conversely, negative metrics, like CVE-based vulnerabilities or release age, are treated as positive criteria for minimization.

With respect to normalization, because an objective function to be minimized is used, values qᵢ for a positive metric q are scaled according to

$$\frac{{q}^{max} - {q}_{i}}{{q}^{max} - {q}^{min}}$$

where q^{min} and q^{max} are, respectively, the minimal and maximal possible values for q. For example, suppose that release popularity ranges from 10 stars to 100 stars. The normalized value for a release with 80 stars (which is quite popular) is

$$\frac{100 - 80}{100 - 10} = 0.22 .$$

Accordingly, values for a negative metric are scaled using

$$1 - \frac{{q}_{i}^{max} - {q}_{i}}{{q}_{i}^{max} - {q}_{i}^{min}} .$$

For example, suppose that release age ranges between 5 days and 365 days. The normalized value for a release that is 300 days old (which is quite old) is

$$1 - \frac{365 - 300}{365 - 5} = 0.82 .$$

To increase computational efficiency of the solver, and to make the possible feedback of quality debt enhancement more legible for developers, a multiplicative factor k (e.g., k=1000) is applied when normalizing. For the non-limiting examples above, values of 220 and 820 would be provided using k=1000.

The objective function of the linear program will be minimized to identify the optimal solution (e.g., solution in Algorithm 1, also denoted as sol) for updating dependencies. An example objective function is provided as:

$$Min ( ( 1 - w ( cost ) ) \times {Quality}_{s o l} + w ( cost ) \times {Cost}_{s o l} ) ) \qquad ( 7 )$$

where, w(cost) is the weight assigned to the cost of change metric, and 1−w(cost) is the weight of the overall quality of the solution, referred to as Qualityₛₒₗ. This overall quality is in turn computed using the following example aggregation function:

$${Quality}_{sol} = {\sum }_{∀ q ∈ Q} w ( q ) \times {f}_{q} \qquad ( 8 )$$

where w(q) is the weight assigned to the quality metric q, and f_{q} is the aggregation function for the computation of the quality metric q of solution sol. The aggregation function of any metric depends on the nature of the criterion it seeks to aggregate. For instance, the aggregation function for vulnerabilities related to CVEs is defined by the sum of the vulnerability values of each release within the solution sol, as illustrated in the following example relationship:

$${f}_{q} = {\sum }_{∀ r ∈ s o l} q ( r ) \times {v}_{r}^{rel} \qquad ( 9 )$$

where q(r) is the vulnerability value of release r and

$${v}_{r}^{rel}$$

is used to prune releases that are not in the solution (e.g., as noted above,

$${v}_{r}^{rel} ,$$

is 1 if release r is present in the solution, else it is 0).

Similarly, the cost of change metric values are aggregated. The cost of change for the solution sol is computed as the sum of the cost of change values associated with change edges within sol as represented in the following example relationship:

$${Cost}_{s o l} = {\sum }_{∀ ( r , {r}^{′} ) ∈ s o l} cost ( r , {r}^{′} ) \times {v}_{{rr}^{′}}^{c h g} \qquad ( 10 )$$

### Here,

$${v}_{{rr}^{′}}^{c h g}$$

is used to prune change edges that are not present in the solution.

After the solution has been determined, an updated set of dependencies is retrieved. More particularly, given the solution, the optimal set of (direct and indirect) dependencies correspond to all nodes r in N_{R}, such that v^{rel}=1 in the solution. However, a specificity of the Maven package manager is that, whenever there are several paths from the project to some library l, the shortest path is used to discriminate between multiple versions of l to be selected. In FIG. 2, for example, there are two paths from the root to l6, one path ending with l5-1, requiring version 2, and another path ending with l2-2, requiring version l, the latter being the shortest. This means that, if the best solution is (l1-3, l2-2, l5-1, l6-2), p's dependency file cannot just be updated using l1-3 instead of l1-1 and l2-2 instead of l2-1, because l6-1 would be used and not l6-2. To address this, p's dependency file can be updated with all releases in the solution (e.g., l1-3, l2-2, l5-1, and l6-2). Although this approach may lock the versions and complicate the dependency file by adding indirect dependencies to the root, it ensures the quality that is being committed to.

In accordance with implementations of the present disclosure, the software dependency update system provides an updated dependency file that defines updated dependencies for a software system (e.g., a project p). In some examples, an updater provides all of the nodes in the solution graph. The dependency description file can be edited to include the nodes provided in the solution graph.

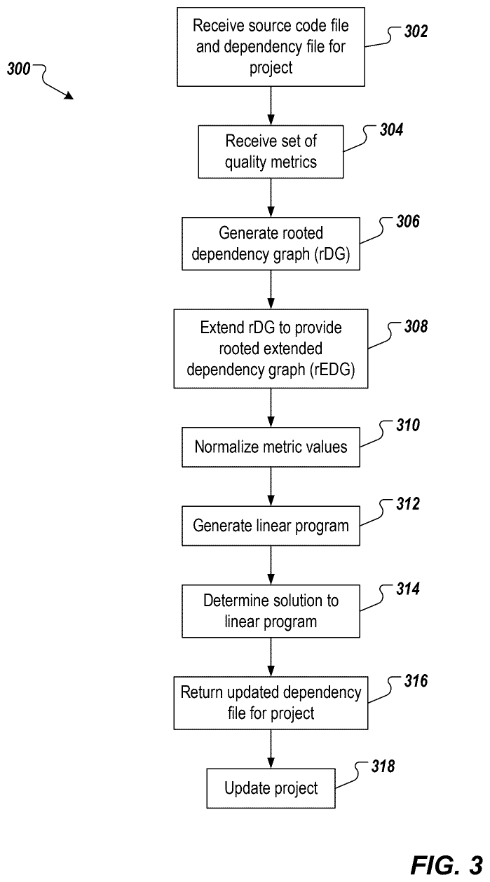

FIG. 3 depicts an example process 300 that can be executed in accordance with implementations of the present disclosure. In some examples, the example process 300 is provided using one or more computer-executable programs executed by one or more computing devices.

A source code file and a dependency description file are received for a project (302). For example, and as described herein, the software dependency update system receives the source code file and the dependency description file for a project. A set of quality metrics is received (304). For example, and as described herein, the software dependency update system receives the set of quality metrics as a non-empty set Q of user-chosen quality metrics, to which a specific cost of change metric (cost) is added, which yields a set Q⁺, and a weight function w that associates, to each q in Q⁺, a user-defined weight (e.g., in [0,1]), with w_{q} denoting the weight for q.

A rooted dependency graph (rDG) is generated (306). For example, and as described herein, the rooted dependency graph (rDG) is constructed from the direct dependencies of the project p, where, in addition to containing all direct and indirect dependencies for the project p, the rDG also includes additional libraries and releases corresponding to a potential for update. The rDG is extended to provide a rooted extended dependency graph (rEDG) (308). For example, and as described herein, the rDG is extended (to provide the rEDG) with the edges in E_{C} and the values in cost to integrate the cost of change in the update process. Metric values are normalized (310). For example, and as described herein, normalization is performed to ensure a consistent basis for comparison when using linear programming. In some examples, values qᵢ for a positive metric q are scaled according to

$$\frac{{q}^{max} - {q}_{i}}{{q}^{max} - {q}^{min}}$$

where q^{min} and q^{max} are, respectively, the minimal and maximal possible values for q.

A linear program is generated (312), a solution to the linear program is determined (314), and an updated dependency file for the project is returned (316). For example, and as described herein, the linear program using a set of decision variables (e.g., possible dependencies) and a set of constraints (e.g., quality metrics), and an objective function that is to be optimized. The linear program is processed through a solver that returns a solution that optimizes the objective function in view of the constraints. In some implementations, the solution is represented within the updated dependency file that is returned by the software dependency update system. The project is updated (318).

Implementations of the present disclosure achieve multiple technical advantages and improvements over traditional approaches to updating dependencies of software systems. For example, implementations of the present disclosure reduce time- and resource-consumption in selecting which dependencies to update, selecting appropriate target versions of libraries, minimizing the impact of updates in terms of breaking changes and incompatibilities, and balancing cost of updating with quality metrics (e.g., freshness, popularity, vulnerabilities, compatibility).

Further, implementations of the present disclosure have been evaluated using a dataset of 107 well-tested open-source Java projects using various configurations that reflect real-world dependency update scenarios. The evaluations considered quality metrics of dependency freshness, a time-window popularity measure, and a vulnerability score related to CVEs, and are detailed in Balancing the Quality and Cost of Updating Dependencies, Damien Jaime, ASE'24, October 27-November 1, Sacramento, CA, USA 2024, which is incorporated herein by reference in the entirety for all purposes. The results of the evaluations are that the approach of the present disclosure generates updates that compile and pass tests as well as the naive approaches typically implemented in dependency bots. Furthermore, implementations of the present disclosure can be up to two orders of magnitude better in terms of freshness. By considering a more comprehensive concept of quality debt, which accounts for freshness, popularity, and vulnerabilities, implementations of the present disclosure are able to reduce quality debt, while maintaining reasonable memory and time consumption.

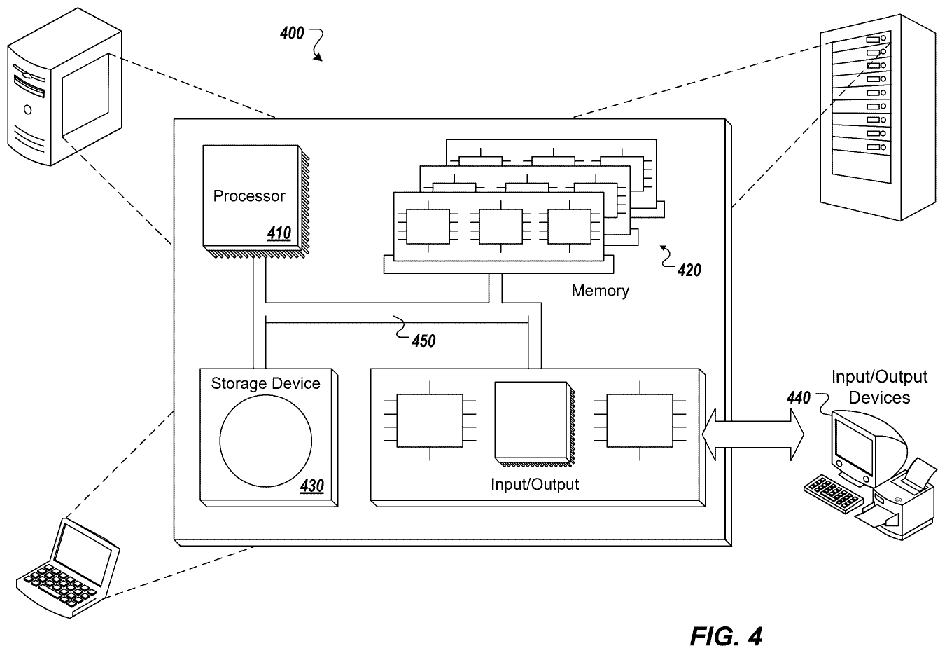

Referring now to FIG. 4, a schematic diagram of an example computing system 400 is provided. The system 400 can be used for the operations described in association with the implementations described herein. For example, the system 400 may be included in any or all of the server components discussed herein. The system 400 includes a processor 410, a memory 420, a storage device 430, and an input/output device 440. The components 410, 420, 430, 440 are interconnected using a system bus 450. The processor 410 is capable of processing instructions for execution within the system 400. In some implementations, the processor 410 is a single-threaded processor. In some implementations, the processor 410 is a multi-threaded processor. The processor 410 is capable of processing instructions stored in the memory 420 or on the storage device 430 to display graphical information for a user interface on the input/output device 440.

The memory 420 stores information within the system 400. In some implementations, the memory 420 is a computer-readable medium. In some implementations, the memory 420 is a volatile memory unit. In some implementations, the memory 420 is a non-volatile memory unit. The storage device 430 is capable of providing mass storage for the system 400. In some implementations, the storage device 430 is a computer-readable medium. In some implementations, the storage device 430 may be a floppy disk device, a hard disk device, an optical disk device, or a tape device. The input/output device 440 provides input/output operations for the system 400. In some implementations, the input/output device 440 includes a keyboard and/or pointing device. In some implementations, the input/output device 440 includes a display unit for displaying graphical user interfaces.

The features described can be implemented in digital electronic circuitry, or in computer hardware, firmware, software, or in combinations of them. The apparatus can be implemented in a computer program product tangibly embodied in an information carrier (e.g., in a machine-readable storage device, for execution by a programmable processor), and method steps can be performed by a programmable processor executing a program of instructions to perform functions of the described implementations by operating on input data and generating output. The described features can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer can include a processor for executing instructions and one or more memories for storing instructions and data. Generally, a computer can also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the features can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The features can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, for example, a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method for updating dependencies in software projects, the method being executed by one or more processors and comprising:
receiving a source code file and a dependency description file of a software project;
receiving a set of quality metrics, each quality metric having a weight assigned thereto;
generating a rooted dependency graph comprising a first set of nodes, each node in the first set of nodes directly depending from a root node of the software project;
extending the rooted dependency graph to provide a rooted extended dependency graph that comprises the first set of nodes and a second set of nodes, a first sub-set of nodes of the second set of nodes representing current dependencies in the software project and a second sub-set of nodes of the second set of nodes representing potential dependencies in an updated version of the software project;
generating a linear program using the rooted extended dependency graph, the set of quality metrics, and a weight function, the linear program being executable to optimize an objective function;
processing the linear program using a solver to generate a solution that represents a third set of nodes and a set of edges between nodes in the third set of nodes that optimize the objective function;
providing an updated dependency file for the software project that is representative of the solution; and
updating the software project using the updated dependency file.

2. The method of claim 1, wherein a first sub-set of nodes in the third set of nodes represents direct dependencies to the root node and a second sub-set of nodes in the third set of nodes represents indirect dependencies to the root node.

3. The method of claim 1, wherein the objective function is optimized by minimizing the objective function.

4. The method of claim 1, wherein the objective function accounts for a quality of the solution in terms of an aggregation of quality metrics of the set of quality metrics and a cost of the solution in terms of change to one or more dependencies in the software project.

5. The method of claim 1, further comprising normalizing values of quality metrics in the set of quality metrics before processing the linear program.

6. The method of claim 1, wherein the rooted extended dependency graph comprises a set of change edges, each change edge being between the root node and a non-root node and representing a cost to change dependency between the root node and the non-root node.

7. The method of claim 1, wherein the set of quality metrics comprises a vulnerability metric, a freshness metric, and a popularity metric.

8. A non-transitory computer-readable storage medium coupled to one or more processors and having instructions stored thereon which, when executed by the one or more processors, cause the one or more processors to perform operations for updating dependencies in software projects, the operations comprising:
receiving a source code file and a dependency description file of a software project;
receiving a set of quality metrics, each quality metric having a weight assigned thereto;
generating a rooted dependency graph comprising a first set of nodes, each node in the first set of nodes directly depending from a root node of the software project;
extending the rooted dependency graph to provide a rooted extended dependency graph that comprises the first set of nodes and a second set of nodes, a first sub-set of nodes of the second set of nodes representing current dependencies in the software project and a second sub-set of nodes of the second set of nodes representing potential dependencies in an updated version of the software project;
generating a linear program using the rooted extended dependency graph, the set of quality metrics, and a weight function, the linear program being executable to optimize an objective function;
processing the linear program using a solver to generate a solution that represents a third set of nodes and a set of edges between nodes in the third set of nodes that optimize the objective function;
providing an updated dependency file for the software project that is representative of the solution; and
updating the software project using the updated dependency file.

9. The non-transitory computer-readable storage medium of claim 8, wherein a first sub-set of nodes in the third set of nodes represents direct dependencies to the root node and a second sub-set of nodes in the third set of nodes represents indirect dependencies to the root node.

10. The non-transitory computer-readable storage medium of claim 8, wherein the objective function is optimized by minimizing the objective function.

11. The non-transitory computer-readable storage medium of claim 8, wherein the objective function accounts for a quality of the solution in terms of an aggregation of quality metrics of the set of quality metrics and a cost of the solution in terms of change to one or more dependencies in the software project.

12. The non-transitory computer-readable storage medium of claim 8, wherein operations further comprise normalizing values of quality metrics in the set of quality metrics before processing the linear program.

13. The non-transitory computer-readable storage medium of claim 8, wherein the rooted extended dependency graph comprises a set of change edges, each change edge being between the root node and a non-root node and representing a cost to change dependency between the root node and the non-root node.

14. The non-transitory computer-readable storage medium of claim 8, wherein the set of quality metrics comprises a vulnerability metric, a freshness metric, and a popularity metric.

15. A system, comprising:
a computing device; and
a computer-readable storage device coupled to the computing device and having instructions stored thereon which, when executed by the computing device, cause the computing device to perform operations for updating dependencies in software projects, the operations comprising:
receiving a source code file and a dependency description file of a software project;
receiving a set of quality metrics, each quality metric having a weight assigned thereto;
generating a rooted dependency graph comprising a first set of nodes, each node in the first set of nodes directly depending from a root node of the software project;
extending the rooted dependency graph to provide a rooted extended dependency graph that comprises the first set of nodes and a second set of nodes, a first sub-set of nodes of the second set of nodes representing current dependencies in the software project and a second sub-set of nodes of the second set of nodes representing potential dependencies in an updated version of the software project;
generating a linear program using the rooted extended dependency graph, the set of quality metrics, and a weight function, the linear program being executable to optimize an objective function;
processing the linear program using a solver to generate a solution that represents a third set of nodes and a set of edges between nodes in the third set of nodes that optimize the objective function;
providing an updated dependency file for the software project that is representative of the solution; and
updating the software project using the updated dependency file.

16. The system of claim 15, wherein a first sub-set of nodes in the third set of nodes represents direct dependencies to the root node and a second sub-set of nodes in the third set of nodes represents indirect dependencies to the root node.

17. The system of claim 15, wherein the objective function is optimized by minimizing the objective function.

18. The system of claim 15, wherein the objective function accounts for a quality of the solution in terms of an aggregation of quality metrics of the set of quality metrics and a cost of the solution in terms of change to one or more dependencies in the software project.

19. The system of claim 15, wherein operations further comprise normalizing values of quality metrics in the set of quality metrics before processing the linear program.

20. The system of claim 15, wherein the rooted extended dependency graph comprises a set of change edges, each change edge being between the root node and a non-root node and representing a cost to change dependency between the root node and the non-root node.
